(19) United States
(12) Patent Application Publication
(10) Pub. No.: US 2010/0210346 A1
(43) Pub. Date: Aug. 19, 2010

(54) System and Method for Rewarding Consecutive Wins in Gaming Activities

(76) Inventors: Bradley Berman, Minnetonka, MN (US); Ryan Strand, Hopkins, MN (US); Adam Martin, St. Louis Park, MN (US); Anand Hurkadli, Eden Prairie, MN (US)

Correspondence Address: Hollingsworth & Funk, LLC, Suite 320, 8500 Normandale Lake Blvd., Minneapolis, MN, 55437, US

(21) Appl. No.: 12/707,195

(22) Filed: Feb. 17, 2010

Related U.S. Application Data
(60) Provisional application No. 61/153,479, filed on Feb. 18, 2009.

(51) Int. Cl. A63F 13/00; A63F 9/24

(52) U.S. Cl. 463/20; 463/26

(57) ABSTRACT

A system and method for rewarding a participant of a gaming activity for achieving a succession of winning results for a corresponding succession of game segments. If winning results are achieved for multiple, consecutive game segments, then the participant is rewarded by augmenting the current payout with a portion of one or more of the previous payouts obtained in the consecutive chain of winning results. An advanced award status is optionally recognized, when the participant has achieved a predetermined number of consecutive winning results. In such an instance, while a particular game segment may have concluded in a losing result, the advanced award status may still be active to enable persistent augmentation of payouts.

### RELATED APPLICATIONS

This application claims the benefit of Provisional Patent Application Ser. No. 61/153,479, filed on Feb. 18, 2009, to which priority is claimed pursuant to 35 U.S.C. §119(e) and which is hereby incorporated herein by reference in its entirety.

### FIELD OF THE INVENTION

This invention relates in general to gaming systems and processes, and more particularly to a method and apparatus for providing a gaming activity that tracks consecutive winning results and rewards the current winning result based upon a portion of the reward(s) from the previous winning result(s).

### BACKGROUND OF THE INVENTION

Gaming devices such as slot machines have provided a manner of entertaining people for over a century. While the fundamental concept behind slot games has remained relatively intact, the manners of computing, displaying, and participating in modern day slot games has changed dramatically. One force driving these changes is technological advancement, such as the advent of computers and video capabilities. Another driving force is human nature, as the participants of such gaming devices demand continual excitement and stimulation. It is therefore important in the gaming industry that gaming innovations continue to be rolled out to the participating public.

Some gaming devices, such as slot machines, base the result of a gaming activity on a “payline.” For example, in the context of slot machines, one, two, or many more predefined paylines may be utilized. These paylines are generally predetermined lines or patterns encompassing a number of display segments on a mechanical or video display grid. If a predetermined symbol combination is presented on the display segments of any of the predetermined paylines, a winning payout result occurs.

Various manners of providing interesting paylines have been devised. The earliest slot machines included one payline, generally including one symbol location from each of three mechanical reels. Later slot machines provided two and three paylines by displaying symbols above and/or below the symbol locations associated with the first payline. This type of slot machine provided, for example, three horizontal paylines. As video technologies started entering the gaming industry, even more types of predetermined paylines were utilized. For example, paylines have been provided in horizontal, diagonal, and vertical arrangements, as well as some predetermined pattern such as V-shaped, zigzag shaped, etc.

Other manners of enhancing gaming activities involves the manner in which payouts are made. One such manner of stimulating interest and heightening excitement has been through the use of “bonus” events. Bonus events or games are used to attract and keep players at a gaming machine. A bonus game is typically an additional gaming reel or machine, or a random selection device, that is enabled by a bonus qualifying signal from an underlying or primary gaming machine. Generally, a predetermined prize-winning combination of symbols in an underlying or primary game may result in the player being awarded one or more bonus games. Often the bonus event has a much higher probability of winning, thereby instilling a great interest by players in being awarded bonus events.

Despite the advances in these areas, other manners of maintaining player interest are needed. Further, it would be beneficial to casino operators to provide a manner of maintaining player interest to increase profitability. For example, it would be beneficial to provide a gaming feature that is applicable to a wide variety of gaming activities. It would also be beneficial to provide such a scalable gaming function that would further continue player participation at a particular gaming machine, even after a player has won a payout. In other words, it is often the case that a player will play a slot machine until he/she has won an acceptable payout, and then take the payout and leave to participate in another slot machine. It would be beneficial to implement a gaming function on such machines that would incentivize players to continue playing on such a gaming machine rather than walking away from the machine, even upon winning a relatively large payout that might otherwise tempt the player to move on to another machine.

The present invention addresses these and other shortcomings of prior art gaming activities. The present invention provides gaming participants with an incentive to continue participating in a gaming activity even if the player has just received a winning payout. The invention provides these and other advantages over prior art gaming activities.

### SUMMARY

To overcome limitations in the prior art described above, and to overcome other limitations that will become apparent upon reading and understanding the present specification, the present invention discloses a system and method for rewarding a participant of a gaming activity for achieving a succession of winning results for a corresponding succession of game segments. If winning results are achieved for multiple, consecutive game segments, then the participant is rewarded by augmenting the current payout with a portion of one or more of the previous payouts obtained in the consecutive chain of winning results. An advanced award status is optionally recognized, when the participant has achieved a predetermined number of consecutive winning results. In such an instance, while a particular game segment may have concluded in a losing result, the advanced award status may still be active to enable persistent augmentation of payouts.

In accordance with one embodiment of the invention, a method for rewarding successful results in multiple game segments comprises tracking payout amounts obtained in response to successful completion of a plurality of game segments occurring prior to the successful completion of a current game segment, selecting a group of payout amounts within the plurality of successfully completed game segments, and augmenting a payout amount for the successful completion of the current game segment in proportion to at least one payout amount within the selected group of payout amounts.

In accordance with another embodiment, a method for rewarding consecutive winning spins during a free spin bonus activity of a slot game comprises detecting a winning spin during the free spin bonus activity, tracking occurrences of winning spins subsequent to the winning spin, and augmenting a payout amount for each subsequent winning spin in proportion to a payout amount associated with a previous winning spin.

In accordance with another embodiment, a casino gaming apparatus hosts a gaming activity having at least a standard mode of operation and a bonus mode of operation. The casino gaming apparatus comprises a video screen to present a display grid having a plurality of display cells and a user interface to facilitate player participation in the standard mode and bonus mode of operation. The casino gaming apparatus further comprises a processor that is configured to place symbols within the display cells in response to a random symbol placement determination occurring during each game segment of the standard mode and the bonus mode of operation. During the bonus mode of operation, the processor allocates a number of free game segments and establishes a winning outcome in response to a particular symbol placement. The processor tracks consecutive winning outcomes of the free game segments and augments a payout amount for each consecutive winning outcome in proportion to a payout amount associated with the immediately preceding winning outcome.

In accordance with another embodiment, a method for facilitating participation in a slot game comprises generating winning and losing results during play of a plurality of slot game segments, tracking a total number of consecutive wins during play of the plurality of slot game segments, asserting a first award state in response to generating a first number of consecutive winning results, and augmenting a payout for each consecutive winning result in proportion to a previous winning result payout during the first award state. The first award state is de-asserted in response to a first occurrence of a losing result subsequent to the assertion of the first award state.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems and methods in accordance with the invention.

### BRIEF DESCRIPTION OF THE DRAWINGS

The invention is described in connection with the embodiments illustrated in the following diagrams.

FIG. 1 illustrates a sequence of game segments and associated payouts in accordance with the present invention;

FIG. 2A illustrates operation of the consecutive win counter of FIG. 1 in accordance with one embodiment of the present invention;

FIG. 2B illustrates operation of the consecutive win counter of FIG. 1 in accordance with another embodiment of the present invention;

FIG. 3 illustrates a sequence of slot game segments and associated payouts in accordance with another embodiment of the present invention;

FIG. 4 illustrates an exemplary embodiment of a casino-style gaming device in which the principles of the present invention may be applied;

FIG. 5 illustrates a more particular embodiment of a casino gaming activity in which the principles of the present invention may be applied;

FIG. 6 is a block diagram of a representative computing system capable of carrying out operations in accordance with the invention;

FIG. 7 is a flow diagram illustrating an exemplary method for augmentation of game segment awards in accordance with one embodiment of the invention;

FIG. 8 is a flow diagram illustrating an exemplary method of tracking consecutive wins using a single counter in accordance with one embodiment of the invention;

FIG. 9 is a flow diagram illustrating an exemplary method of tracking consecutive wins using two counters in accordance with one embodiment of the invention;

FIG. 10 is a flow diagram illustrating an exemplary method of augmenting a current payout in accordance with one embodiment of the invention;

FIG. 11 is a flow diagram illustrating an exemplary method of augmenting a current payout in accordance with another embodiment of the invention;

FIG. 12 is a flow diagram illustrating an exemplary method of decrementing consecutive win counters in accordance with one embodiment of the invention; and

FIG. 13 is a flow diagram illustrating an exemplary method for augmentation of game segment awards in accordance with another embodiment of the invention.

### DETAILED DESCRIPTION OF EMBODIMENTS OF THE INVENTION

In the following description of the invention, reference is made to the accompanying drawings which form a part hereof, and in which is shown by way of illustration the specific embodiment in which the invention may be practiced. It is to be understood that other embodiments may be utilized, as structural and operational changes may be made without departing from the scope of the present invention.

Generally, the present invention is directed to a method and apparatus for facilitating participation in any casino gaming activity that may be broken down into gaming segments, where each gaming segment results in either a losing or a winning result. Each winning result may then be associated with a payout for that particular gaming segment. A player's participation in such a casino gaming activity is further rewarded for the current winning result if prior, consecutive gaming segments also resulted in winning results. In such an instance, the payout for the current winning result is then augmented by the payout amount(s) of the previous win(s).

The present invention, as described more fully below, is applicable to a variety of gaming activities that may be played on a gaming machine, including slot games such as reel slots and video slots, electronic poker and other electronic card games, keno, bingo, craps, dice, roulette, etc. Accordingly, the present invention is described in large part in the present description in terms of slot machines to provide an understanding of the invention. For example, in the context of slot games/machines, the present invention allows slot game participants to partake in a standard slot game(s), while having the opportunity to be rewarded for consecutive wins. While the invention is particularly advantageous in the context of slot machines, and while a description in terms of slot machines facilitates an understanding of the invention, the invention is applicable to other gaming activities of chance as will be readily apparent to those of skill in the art from the description provided herein.

An exemplary gaming system in which the principles of the present invention are particularly beneficial includes a standard gaming activity having a number of associated gaming segments and related outcomes. For example, in the context of slot machines, a standard gaming activity includes the normal slot game in which the participant places a wager, initiates spinning or otherwise activating the slot game reels, and collects payouts upon the occurrence of any of a plurality of predetermined winning symbol combinations. An accumulation of occurrences of the predetermined winning symbol combinations may then result in consecutive occurrences of two or more winning symbol combinations, which in the context of the present invention, yields an augmented payout that is based upon the payout of one or more of the previous winning results. That is to say, by achieving consecutive winning results, the player establishes any number of chained wins that may be effective to augment the payout obtained for the current game segment. Thus, the amount of the payout for the current game segment is based in whole or in part upon one or more of the payouts of the previous winning results.

More particularly, an exemplary gaming system in which the principles of the present invention are beneficial includes a standard gaming activity. For example, in the context of slot machines, the occurrence of a predetermined symbol combination(s) may give rise to a winning result for that particular game segment. A subsequent occurrence of the same or different winning symbol combination represents a consecutive win, whereby in one embodiment the payout is at least based upon the payout amount of the immediately preceding win (although may alternatively or additionally be based on prior wins that are not immediately preceding the current game segment). The payout may further be augmented by the payout amounts of yet other previous wins existent within the current winning “chain.”

The present invention is applicable in connection with standard gaming activities and/or with bonus gaming activities. A bonus activity differs from a standard gaming activity in that it generally only occurs at certain times, such as an occurrence of a particular gaming event (e.g., a particular symbol combination). In other words, where a standard gaming activity may represent the gaming activity presented to the participant as a matter of course during play of the gaming device, a bonus activity may not be automatically presented to the participant. Rather, the bonus activity represents a special occurrence awarded to the participant as a result of participating in the standard gaming play. For example, a bonus event may be awarded to a slot game participant if a resulting symbol combination occurring during standard slot game activity corresponds to a symbol combination determined in advance to result in a bonus event. Bonus events are typically used to attract and keep players at a gaming machine, and is typically an additional gaming reel or machine, or a random selection device, that is enabled by a bonus qualifying signal from an underlying or primary gaming activity. Generally, a predetermined combination of symbols in an underlying game may result in the player being awarded one or more bonus games. Often the bonus event has a much higher probability of winning, thereby instilling a great interest by players in being awarded bonus events.

In the context of slot machines, a bonus event in accordance with the invention may provide the participant with a number of free spins. As a result, a consecutive win accumulator in accordance with the present invention may be invoked to track chained wins that may occur during the free spin activity. For example, the first free spin of the bonus activity may enable the consecutive win accumulator, such that if a predetermined combination of symbols is generated that results in a winning result, the consecutive win accumulator may be initialized to a value of one. If a winning result is obtained on the subsequent spin, the consecutive win accumulator may then be incremented to a value of two, thus indicating that two consecutive wins have been achieved during the bonus activity. A consecutive win award calculator may then calculate a payout for the second win, that incorporates a portion of the payout amount earned during the first win of the consecutive win chain. A subsequent win may then cause the consecutive win accumulator to increment to three, which then invokes the consecutive win award calculator to calculate a payout for the third win that incorporates a portion of the payout amount earned on the second win of the consecutive win chain and/or may augment the payout amount for the third win using the payout amount earned on the first win of the consecutive win chain. The consecutive win chain may continue as described above for all free spins, may be reset on any losing spin during the bonus activity, etc. Other operational embodiments regarding augmented payouts based on chained win combinations are discussed in more detail below.

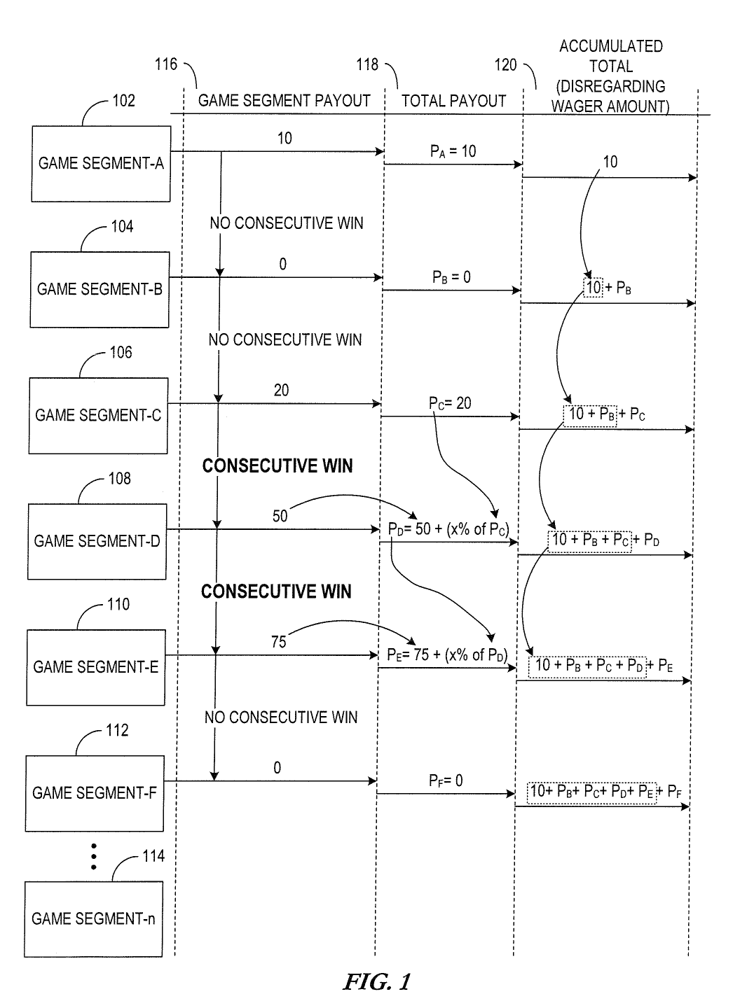

In order to provide an understanding of the operation of the present invention, FIG. 1 illustrates a sequence of game segments carried out in connection with any casino gaming activity in accordance with one embodiment of the invention. Game segments 102-114 exemplify operation of virtually any casino gaming activity that may be characterized as a sequence of one or more segments resulting in a win/loss determination at the end of each segment. For example, in the context of slot machines, a game sequence includes the normal slot game in which the participant places a wager, initiates spinning the slot game reels, and collects payouts upon the occurrence of one of a plurality of predetermined winning symbol combinations. The participant having executed a first winning symbol combination during the first game segment then becomes eligible to become a consecutive game segment winner upon a winning result of the subsequent game segment.

In the context of a video poker machine, a game sequence includes the dealing of an electronic poker hand in response to the participant placing a wager. After some intermediate electronic card exchanges between the electronic dealer and the participant, a winning or a losing result of the game segment is achieved through a determination of electronic card combinations ultimately retained by the participant. Should the participant retain a hand resulting in a predetermined winning electronic card combination, the participant is deemed to be a winner for that game segment. The participant then becomes eligible on the next game segment to become a consecutive game segment winner should a predetermined winning electronic card combination again be retained by the participant at the end of the subsequent game segment.

In the context of a gaming table such as roulette, black jack, poker, craps, etc., a game segment is defined as the placement of a wager or wagers, followed by, or concurrently with, gaming activity in accordance with the gaming rules applicable to that particular gaming activity. A determination as to any winning results obtained by any of the gaming participants is then made at the conclusion of the particular game segment. Should any one or more of the gaming participants be declared winners, they are then eligible to become consecutive game segment winners in the event that they again achieve a winning result at the conclusion of the subsequent game segment.

FIG. 1 exemplifies one embodiment of how a participant of any casino gaming activity may become a consecutive game segment winner in accordance with one embodiment of the present invention. At the conclusion of game segment-A 102, the participant is deemed to have met the threshold requirements for that particular game segment to obtain a winning result, for which the game segment payout is 10. A game segment payout, for example, may represent a cash value of the winning result, which may then be paid to the participant immediately. Conversely, a game segment payout may be accumulated in terms of credits, or tokens, which may then be subsequently converted into a cash value or alternatively into wagers for additional game segments. In any event, whether the payout is in credits, cash, tokens, etc., a total payout for game segment-A 102 is determined to be 10 as illustrated by the total payout indication, P_{A}, of column 118. Since game segment-A 102 represents the first game segment of a chain of game segments, the accumulated total of payouts is also determined to be 10 as illustrated by the accumulated total of column 120.

In one embodiment, the participant of game segment-A 102 may now be automatically eligible to become a consecutive game segment winner by virtue of the winning result for game segment-A 102. In such an instance, the participant would in fact become a consecutive game segment winner should the result of game segment-B 104 also be a winning result. In other embodiments, the excitement of the gaming participant may be elevated somewhat, if the eligibility to become a potential consecutive game segment winner were not only dependent upon a winning result of a subsequent game segment, but also upon some other event. In such an instance, the gaming participant is placed into a temporary state of heightened anticipation, whereby after having won his or her first game segment, he or she waits for an indication from the gaming device/table, as to his or her eligibility to become a potential consecutive game segment winner. Such an event may be randomly selected by an affirmative outcome, for example, of a random number generator (RNG).

In another embodiment, the participant may increase his or her probability of becoming eligible for consecutive game segment winner status, for example, by wagering an extended amount prior to commencement of the game segment. In another embodiment, the participant's probability of becoming eligible for consecutive game segment winner status may be enhanced/diminished by his or her past performance on the particular gaming device/table. In another embodiment, a predetermined number of wins must be established before the participant may become eligible to become a consecutive game segment winner.

In any event, the participant may be alerted as to his or her eligibility for consecutive game segment winner status by any number of visual, audible, or tactile queues. Accordingly, after having been so alerted, the participant may increase his or her anticipation of a subsequent winning result in response to the eligibility queue. As exemplified by the result of game segment-B 104, however, the participant is unable to achieve the status of consecutive game segment winner, since the winning result of game segment-A 102 was not immediately followed by a winning result in game segment-B 104. Thus, after two consecutive game segments, only one winning result is obtained with an accumulated payout of 10 as illustrated in the accumulated total of column 120.

At the conclusion of game segment-C 106, the participant is again deemed to have met the threshold requirements for that particular game segment to obtain a winning result, for which the payout for game segment-C, P_{C}, is 20. Once again, therefore, the participant may become eligible for consecutive game segment winner status, either automatically by virtue of having won game segment-C 106, or in combination with another qualifying event as discussed above.

In the event that the participant has automatically earned the right to become eligible for consecutive game segment winner status, then prior to commencement of game segment-D 108, the participant is alerted as to his or her eligibility for becoming a consecutive game segment winner. As such, anticipation of a winning result for game segment-D 108 is thus heightened, since by operation of the present invention, the participant is to be rewarded based not only on the normal payout for game segment-D 108, P_{D}, but also in some proportion to the amount of the payout received during the previous game segment-C 106, i.e., x % of P_{C}. As can be seen, the participant has in fact met the threshold requirements to obtain a winning result for game segment-D 108, and as such, is deemed to be paid in accordance with an augmented payout structure since the participant is now a consecutive game segment winner. Thus, the total payout for game segment-D 108 is equal to P_{D}=50+x*P_{C}, where 50 is the normal payout for game segment-D 108 and x is an augmentation multiplier used to obtain an augmentation amount earned by the participant by virtue of becoming a consecutive game segment winner.

In one embodiment, x may be a number less than or equal to one, to signify that the augmentation amount is to be some percentage, less than or equal to 100%, of the previous game segment payout, e.g., P_{C}. The percentage may be fixed, or alternately chosen as a result of an RNG. In an alternate embodiment, x may represent one of a discrete number of percentages, e.g., 25% and 50%, whereby in accordance with the RNG, or conversely through alternate selection, either of the 25% or 50% values are chosen for x. In another embodiment, x may represent a number greater than one, so that percentages greater than 100% may be used to calculate the augmentation amount.

Prior to the commencement of game segment-E 110, the participant is once again alerted as to his or her eligibility status to become a consecutive game segment winner. Anticipation of a winning result for game segment-E 110 is heightened even further, since the participant is aware that the previous payout for game segment-D 108, P_{D}, was an augmented payout. In other words, the participant is aware that if a winning result for game segment-E 110 is obtained, then augmentation of the payout for game segment-E 110 is to be compounded by the augmented payout received for game segment-D 108. That is to say, that the payout for game segment-E 110 is equal to P_{E}=75+y*P_{D}=75+y(50+x*P_{C}), where a first order augmentation term, y*50, and a second order augmentation term, y*x*P_{C}, are both obtained as illustrated by total payout column 118. Thus, the participant has received an augmented payout that has been compounded by virtue of the fact that the participant has won two consecutive game segments.

It can be seen, therefore, that due to compounded augmentation, the amount of payouts received for each consecutive win can increase exponentially as illustrated by accumulated total column 120. As such, the augmentation multiplier may be successively diminished after each consecutive win to control the magnitude of the compounded augmentation. In one embodiment, the augmentation multiplier may be halved for each successive win, such that if, for example, the augmentation multiplier, e.g., x, were set to ½ for the first consecutive win, the next augmentation multiplier, e.g., y, would be set to ¼, the next to ⅛, and so on. It can be seen, therefore, that the augmentation multiplier may be set in accordance with specific profit margin goals to be obtained, on average, with the particular gaming device that is in use.

In another embodiment, the augmentation multiplier may be initially set to a very small number, e.g., 1/256, and progressively increased after each successive win. In such an instance, for example, the augmentation multiplier may be incrementally increased, e.g., by a factor of two for each successive win, such that the second win yields an augmentation of 1/128, the third win yields an augmentation of 1/64, etc.

Prior to the commencement of game segment-F 112, the participant is once again alerted as to his or her eligibility status to become a consecutive game segment winner. Since the participant has not obtained a winning result for game segment-F 112, then in one embodiment, the participant's eligibility to become a consecutive game segment winner for the immediately subsequent game segment is automatically removed. That is to say, that the participant must first obtain another win before becoming eligible to become a consecutive game segment winner, since the chain of consecutive wins, e.g., the winning results for game segments 106-110, has been broken by the losing result in game segment-F 112. In such an instance, the tracking technology used to track the number of consecutive wins achieved by the participant is effective to reset the consecutive win counter from a value of 3 (3 consecutive wins accumulated for game segments 106-110), to a value of 0.

In an alternate embodiment, only a portion of the participant's prior history of consecutive wins may be zeroed out, such that notwithstanding the losing outcome achieved for game segment-F 112, the participant may nevertheless be given credit for having achieved three, or more, consecutive wins in a row. In such an instance, for example, the consecutive win counter may instead be set to a number that is less than three, but greater than zero, e.g., 2, such that the consecutive win chain is not broken, but is instead shortened. Should the subsequent game segment conclude with a losing result, then the consecutive win counter would again be decreased by a number that is less than two, but greater than zero, e.g., 1.

It can be seen, therefore, that the gaming participant may be rewarded, not only through operation of the augmented payouts as discussed above, but may further be rewarded through manipulation of the consecutive win counter in accordance with the participant's level of play. A participant's level of play, for example, may be measured by the participant's ability to chain a configurable number of consecutive wins together, whereby the participant's ability is measured and rewarded in direct proportion to the number of consecutive wins accumulated.

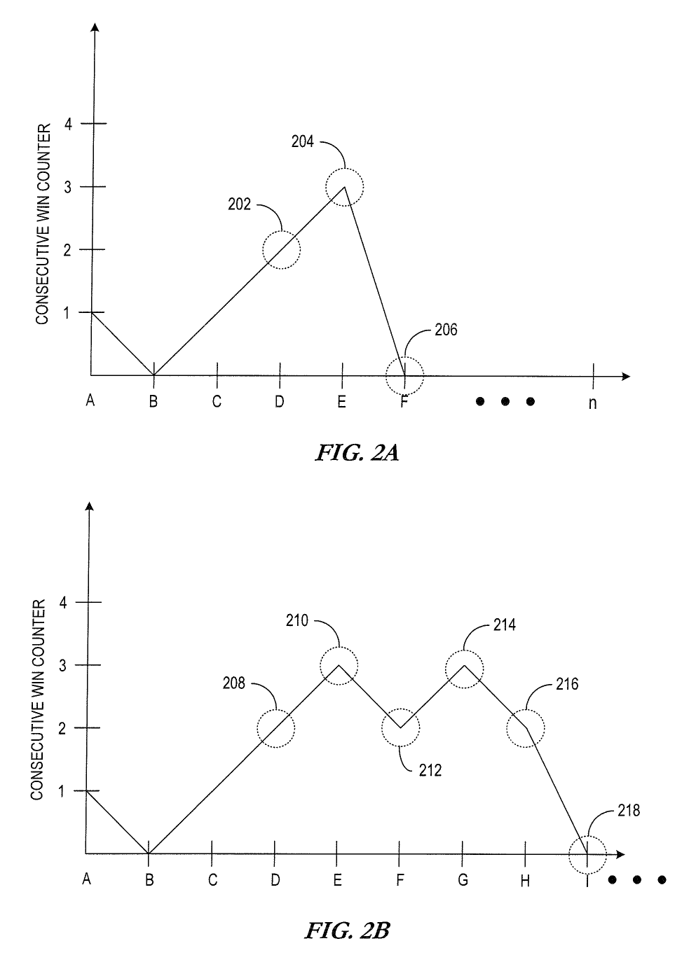

For example, a gaming participant may be engaged in a particular gaming activity that provides consecutive win counter tracking technology as illustrated in FIG. 2A. The consecutive win counter is incremented and decremented through game segments A, B, and C as expected, whereby a win during game segment-A results in a corresponding consecutive win counter increment to 1, a loss during game segment-B results in a corresponding win counter decrement back to 0, and a win during game segment-C results in a corresponding win counter increment back to 1. A subsequent win during game segment-D, results in a corresponding increment of the consecutive win counter to 2, thus earning the participant an augmented payout for event 202. A subsequent win during game segment-E, results in a corresponding increment of the consecutive win counter to 3, thus earning the participant an augmented payout for event 204 that has been compounded by the augmented payout of event 202.

At event 204, the participant's level of play is increased from a baseline value, due to the fact that 3 consecutive wins have been chained together. That is to say that the participant's level of play is baselined at a particular value that corresponds to having chained 2 consecutive game segment winning results together and is increased to an intermediate level of play by virtue of having chained 3 consecutive game segment winning results together. The participant's intermediate level of play may then be compared to a predetermined level of play at event 204, which if met, would propel the participant into an advanced award scenario. Otherwise, after concluding game segment-F with a loss as denoted by event 206, the participant's level of play may be reset to a baseline value with commensurate payouts.

On the other hand, the participant may achieve a baseline level of play at event 208 of FIG. 2B by chaining 2 consecutive winning results together. A subsequent winning result as denoted by event 210, i.e., 3 chained winning results, may establish the participant as meeting a level of play that warrants an advanced award scenario. In one embodiment, the advanced award scenario rewards the participant even in the event of a losing game segment, by decrementing the consecutive win counter to 2, as denoted by event 212, instead of resetting the consecutive win counter to 0, as would otherwise be the case. In such an instance, therefore, even though the participant has not achieved a winning result in game segment-F, he or she nevertheless remains eligible to become a consecutive game segment winner in game segment-G, if a winning result is obtained during game segment-G.

A subsequent win in game segment-G, as denoted by event 214, once again places the participant into consecutive game segment winner status, which then results in an augmented payout. The augmented payout, however, cannot be based on the winnings associated with game segment-F, since no winnings were earned for game segment-F. In such an instance, as is discussed in more detail below, the winnings from game segments-C, D, and/or E may instead be used to determine the augmented payout for game segment-G.

In addition, since the participant has once again been distinguished at a level of play that warrants an advanced award scenario through his or her win during game segment-G, then he or she is nevertheless rewarded at game segment-H, even though game segment-H resulted in a loss. The reward is manifested through a decrement by one of the consecutive win counter, instead of a reset of the consecutive win counter, as would otherwise be the case. A losing result during game segment-I, however, is effective to render the participant at a baseline level of play and commensurate payout, thus causing the consecutive win counter to be reset to 0.

Thus, it can be seen that a first persistence-based concept is contemplated by the present invention, that rewards a gaming participant for his or her ability to chain two, or more, consecutive wins together. Thus, by persistently winning consecutive game segments, the participant's payouts are augmented in variable proportion to one, or more, of the previous game segment payouts.

A second persistence-based concept is contemplated by the present invention, which further rewards the participant when the participant achieves a level of play that is consistent with an advanced award scenario. In such an instance, a number of consecutive wins, equal to a predetermined consecutive win count, earns the participant the right to lose one, or more, subsequent game segments, while maintaining his or her eligibility to obtain consecutive game segment winner status. In such a way, the participant persists in his or her consecutive win eligibility, by maintaining the consecutive win counter above the predetermined consecutive win count. Once the participant's consecutive win counter has dropped below the predetermined consecutive win count, then the advanced award scenario is removed by a subsequent loss, leaving the participant in a position to once again earn his or her way back into an augmented payout persistence, and possibly into an advanced award persistence as discussed above.

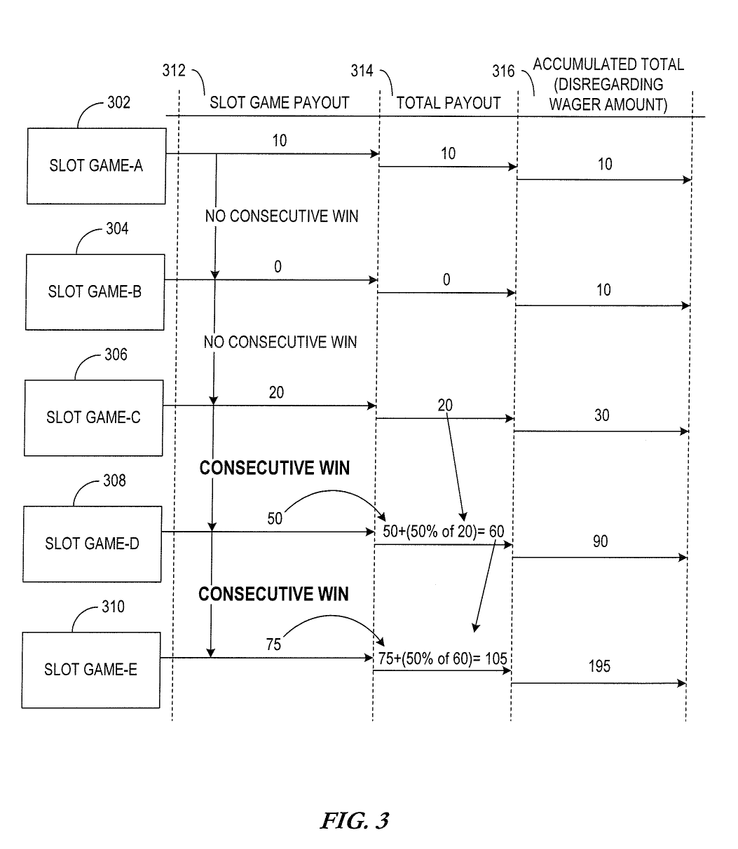

FIG. 3 exemplifies a more particular embodiment of how a participant may become a consecutive winner in relation to a slot game. At the conclusion of slot game-A 302, the symbol combination resulting from a first spin of the slot game provides a winning result, for which the payout is 10 as indicated in slot game payout column 312. Since slot game-A 302 represents the first spin of a chain of spins, the accumulated total of payouts is also determined to be 10 as illustrated by the accumulated total of column 316.

In one embodiment, the participant of slot game-A 302 is now eligible to become a consecutive game segment winner by virtue of obtaining a winning symbol combination as the result of the first spin represented by slot game-A 302. In addition, the participant may be alerted as to his or her eligibility for consecutive game segment winner status by any number of visual, audible, or tactile queues, such as may be provided by sirens, lights, and vibration generators associated with a slot machine. As exemplified by the result of slot game-B 304, however, the participant is unable to achieve the status of consecutive slot game winner, since the winning symbol combination of slot game-A 302 was not immediately followed by a winning symbol combination in slot game-B 304. Thus, after two consecutive spins, only one winning result is obtained with an accumulated payout of 10 as illustrated in the accumulated total of column 316.

At the conclusion of slot game-C 306, the participant has achieved a winning symbol combination, for which the payout for slot game-C, P_{C}, is 20. Once again, therefore, the participant has become eligible for consecutive slot game winner status by virtue of having won slot game-C 306, whereby the participant may be alerted as to his or her eligibility for becoming a consecutive slot game winner. As can be seen, the participant has obtained a winning symbol combination for game segment-D 308, and as such, is deemed to be paid in accordance with an augmented payout structure since the participant is now a consecutive slot game winner. Taking the augmentation multiplier to be equal to 50%, for example, the total payout for slot game-D 308 is equal to P_{D}=50+0.50*20=50+10=60, where 50 is the normal payout for game segment-D 308 and 10 is the augmentation amount earned by the participant by virtue of becoming a consecutive slot game winner.

Since a winning symbol combination concludes slot game-E 310, the user is once again deemed a consecutive slot game winner, where the payout for slot game-E 310 is equal to P_{E}=75+0.50*60=105, where 75 is the normal payout for slot game-E 310 and 30 is the augmentation amount earned by the participant by virtue of becoming a consecutive slot game winner twice in a row. It can be seen that the augmentation amount received in slot game-E 310 is triple the augmentation amount received in slot game-D 308, which is a result that is attributed to compounded augmentation, which ultimately leads to an accumulated winnings total of 195 as illustrated by accumulated total column 316.

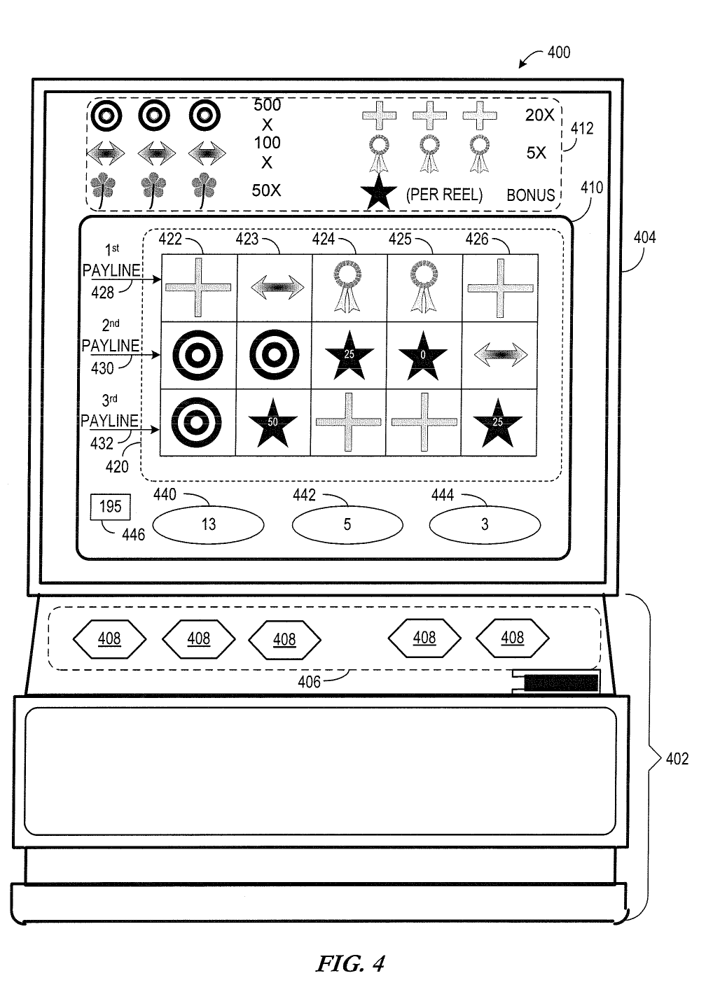

FIG. 4 is an embodiment of a casino-style gaming device in which the principles of the present invention may be applied. Many traditional casino table games may be provided in a “video game” available via a casino-style gaming device shown in FIG. 4. For purposes of explanation, the description of the gaming device in FIG. 4 is provided in terms of a slot machine 400. However, the present invention is analogously applicable to other casino-style games having the ability to provide gaming segments concluding in either a winning or a losing result, which may include mechanical embodiments of the casino-style games as well.

The slot machine 400 is a structure including at least a computing system, a housing, and a display. The housing includes a base 402 and a display device 404 to allow the slot machine 400 to be a self-supported, independent structure. The base 402 includes structure supporting the slot machine 400, and also includes a user interface 406 to allow the user to control and engage in play of the slot machine 400. The particular user interface mechanisms associated with user interface 406 are dependent on the type of gaming machine. For example, the user interface 406 may include one or more buttons, switches, joysticks, levers, pull-down handles, trackballs, voice-activated input, or any other user input system or mechanism that allows the user to play the particular gaming activity. The user input 406 allows the user to enter coins or otherwise obtain credits through vouchers, tokens, credit cards, etc. Various mechanisms for entering such vouchers, tokens, credit cards, coins, etc. are known in the art. For example, coin/token input mechanisms, card readers, credit card readers, smart card readers, punch card readers, and other mechanisms may be used to enter wagers. It is through the user input 406 that the user can initiate the standard mode of play, and may optionally control certain aspects of the bonus mode of play. In the case of a slot machine, the user input may include a plurality of buttons, e.g., button 408, which allow the user to enter a number of credits to play, identify the number of paylines in which to participate, cash out, automatically bet the maximum amount and paylines, etc. It should be recognized that a wide variety of other user interface options are available for use in connection with the present invention, including pressing a button on a gaming machine, touching a segment of a touch-screen, entering text, entering voice commands, or other known user entry methodology. The particular user interface mechanism employed is not relevant to the present invention.

The display device 404 includes a display screen 410. The display device may take on a variety of forms depending on what type of presentation is to be provided. For example, a slot game area 420 is provided where the standard slot gaming activity is displayed. In this example, the standard slot gaming activity includes five video reels 422, 423, 424, 425, and 426, and three paylines depicted as the 1^{st} payline 428, the 2^{nd} payline 430, and the 3^{rd} payline 432. The display segments occur at the intersections of each video reel and payline.

Also associated with the display device 404 is an optional winning guide area 412, where information associated with the potential winning symbol combinations of the standard slot game activity may be presented. This area may also provide an indication of the requisite symbols, symbol combinations, symbol locations, etc. that are required to invoke the bonus mode in accordance with the invention. This information may be part of the display screen 410, or alternatively may be separate from the display screen 410 and provided directly on a portion of the display device 404 structure itself. For example, a backlit colored panel may be used as the winning guide area 412.

Display area 440 may represent, for example, the number of free spins earned during, for example, a bonus gaming activity of slot game 400. In accordance with the present invention, free spins 440 may designate the number of spins provided to the participant during the bonus activity, in which the user may attempt to obtain a winning symbol combination on any, or all, of paylines 428-432. A winning combination on any, or all, of paylines 428-432 constitutes a winning combination, each occurrence of which, may be accumulated by the consecutive win counter during the bonus activity. The accumulated consecutive win count may be displayed to the participant via display 444, such that the participant may be reminded as to his consecutive win count progress throughout the bonus activity, as well as being rewarded by the augmented payouts as discussed above.

In addition, display 442 may represent a predetermined win count that is indicative of a level of play that corresponds to an advanced award scenario. That is to say, for example, that once the consecutive win counter of display 444 exceeds or equals the predetermined win count of display 442, then the participant not only receives augmented payouts for winning combinations at paylines 428-432, but in addition, receives the consecutive win counter decrement attributes discussed above in relation to FIG. 2B.

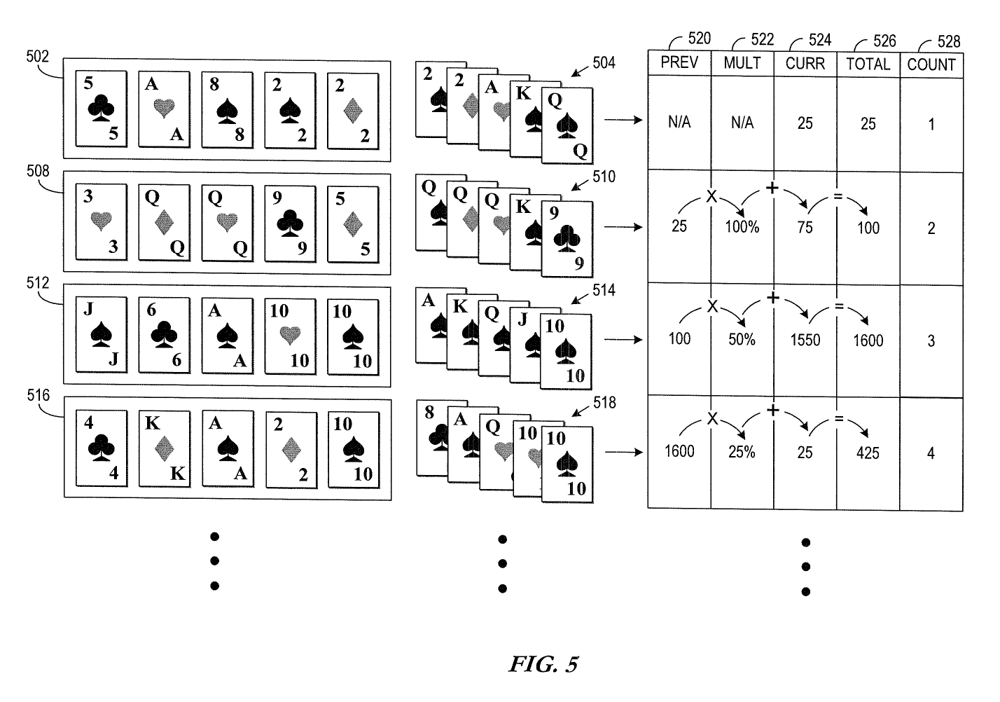

In an alternate embodiment, the principles of the present invention may be applied to casino gaming activities as they relate to card games. While virtually any card hand that concludes with a winning or a losing result may find application in the present invention, the draw poker embodiment of FIG. 5 is discussed to facilitate an understanding of the operation of the present invention. It should be noted that the draw poker embodiment of FIG. 5 may be implemented electronically by a gaming device similar to that illustrated in FIG. 4, where display screen 410 may be used to present the initial hand dealt after a wager, as well as the final hand that remains after the discard and replacement round has completed. In addition, payout and consecutive win counter statistics 520-528 may be accumulated and displayed via display areas 440-446 as discussed above in relation to FIG. 4. Similarly, initial hand requests, discards, and wager amounts may be input by the user via user input 406.

Initial hand 502, for example, may represent the initial hand of a standard mode of play that is dealt to a gaming participant, such that previous payout amount 520 and augmentation multiplier 522 statistics are not applicable (N/A). In another embodiment, initial hand 502 may represent the first hand of a bonus mode of play that has been initiated for the participant in response to the participant's play during the standard mode of play. In the latter case, a particular number of credits may be established for the participant during the bonus mode of play, where each credit established earns the participant the right to execute one hand of draw poker. The participant may then exchange each credit for one hand of draw poker, in the hopes of obtaining a maximum number of consecutive wins, so that accumulated total winnings 526 may be maximized during the bonus mode of play.

Initial hand 502 is followed by the discard and replacement round, such that final hand 504 contains a single pair of 2's concluding the hand in a winning result having current payout 524 equal to 25. Accordingly, consecutive win counter 528 is set to a value of one to denote that the participant is eligible to become a consecutive poker hand winner. Subsequent hand 508 yields a pair of queens, and through appropriate discard and replacement, final hand 510 yields a third queen, thus concluding in a winning result having current payout 524 equal to “75”.

In one embodiment, the participant may be deemed to be an automatic consecutive poker hand winner by virtue of having obtained a second, consecutive winning result for hand 510. In another embodiment, the participant may have to qualify the second consecutive win with a minimally acceptable poker hand before obtaining consecutive poker hand winner status. In such an instance, for example, the minimally acceptable poker hand may be predetermined to require a pair of jacks. Thus, by concluding the hand with three queens, the participant has earned the right to increment consecutive win counter 528 and to receive an augmented payout. In the example of FIG. 5, the augmentation multiplier starts at 100% and thus results in an augmented payout of 25, i.e., 100% of 25 is 25, which is then added to current win payout 524 of 75 for accumulated win total 526 of 100.

Subsequent hand 512 yields the possibility for the participant to conclude with a royal straight flush, since the participant is initially holding spade suited, partial royalty. As luck would have it, the appropriate discard and replacement round did, in fact, conclude with a royal straight flush, which in this example, resulted in current payout 524 of 1550. Thus, final hand 514 represents the third consecutive winning result for the participant, which increments consecutive win counter 528 to 3 and augments the current payout amount by 50% of 100, to yield total payout 526 of 1600. In an alternate embodiment, the augmented payout may not only be based on the immediately preceding payout, but may be based on one or more of the immediately preceding payouts. Thus in this example, a royal straight flush may represent a winning result that is determined to warrant an advanced payout structure, such that 50% of all of the previous consecutive payouts is used to augment the current payout. In such an instance, the augmented payout is calculated to be 50% of (100+25)˜63.

In any event, the participant stands to receive a substantially augmented payout on subsequent hand 516 should it conclude with a winning result, by virtue of the fact that final hand 514 yielded such a high payout. Initial hand 516, however, yields no winning card combination, but hoping for another royal straight flush, the participant retains the flush suited royalty, discards the remaining cards, and concludes with a pair of 10s in final hand 518. Once again, the participant may have automatically earned consecutive win status by virtue of having won the immediately preceding hand, or conversely, may have been required to qualify the consecutive win with, for example, at least a pair of jacks. In the former case, the participant is automatically deemed to be a consecutive hand winner, whereby the consecutive win counter increments by one to 4 and the relatively modest current winning amount 524 of 25 is considerably augmented by 400, i.e., 25% of 1600 is 400, for a total payout of 425.

In one embodiment, the number of hands played during the bonus activity is equal to the number of credits received by the participant when the bonus activity is initiated. In an alternate embodiment, the number of hands played during the bonus activity is dependent upon the participant's consecutive win status during the bonus activity. For example, if the participant was provided with a total of 10 credits for the bonus activity, but was only able to chain three consecutive wins together, then the participant will have forfeited the remaining 6 credits due to the losing result of hand number four. In yet another embodiment, should the participant reach a number of consecutive wins during the bonus activity that warrants an advanced award scenario, the number of hands played during the bonus activity is a function of the participant's advanced award status as discussed above in relation to FIG. 2B. Thus, as long as the consecutive win counter has not been reset, the gaming participant may continue play even beyond the number of bonus games originally awarded at the start of the bonus activity.

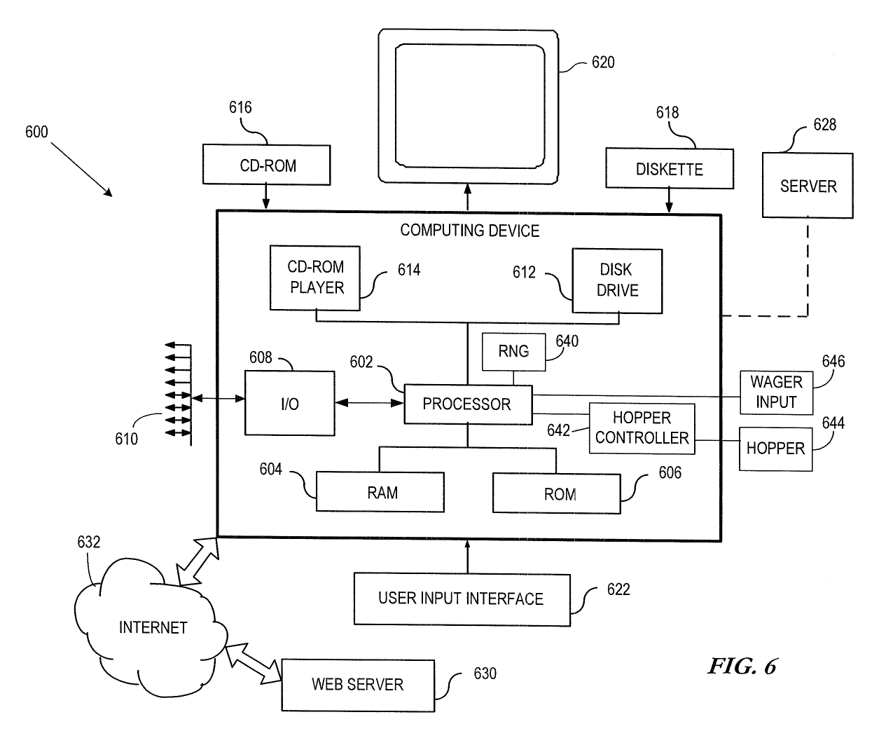

The gaming machines described in connection with the present invention may be independent casino gaming machines, such as slot machines or other special purpose gaming kiosks, video games, or may be computing systems operating under the direction of local gaming software and/or remotely-provided software such as provided by an application service provider (ASP). The casino gaming machines utilize computing systems to control and manage the gaming activity. An example of a representative computing system capable of carrying out operations in accordance with the invention is illustrated in FIG. 6.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 600 of FIG. 6 is an example computing structure that can be used in connection with such electronic gaming machines, computers, or other computer-implemented devices to carry out operations of the present invention.

The example computing arrangement 600 suitable for performing the gaming and chained win functions in accordance with the present invention typically includes a central processor (CPU) 602 coupled to random access memory (RAM) 604 and some variation of read-only memory (ROM) 606. The ROM 606 may also be other types of storage media to store programs, such as programmable ROM (PROM), erasable PROM (EPROM), etc. The processor 602 may communicate with other internal and external components through input/output (I/O) circuitry 608 and bussing 610, to provide control signals, communication signals, and the like.

Chance-based gaming systems such as slot machines, in which the present invention is applicable, are governed by random numbers and processors. Electronic reels are used to display the result of the digital reels which are actually stored in computer memory and “spun” by a random number generator (RNG). RNGs are well-known in the art, and may be implemented using hardware and/or software operable in connection with the processor 602, or some other combination of hardware and software. In accordance with generally known technology in the field of slot machines, the processor 602 associated with the slot machine, under appropriate program instruction, can simulate the vertical rotation of multiple reels. Generally, the RNG continuously cycles through numbers, even when the machine is not being played. The slot machine selects, for example, three random numbers. The numbers chosen at the moment the play is initiated are typically the numbers used to determine the final outcome, i.e., the outcome is settled the moment the reels are spun. The resulting random numbers are generally divided by a fixed number. This fixed number is often thirty-two, but for slot machines with large progressive jackpots it may be even greater. After dividing, the remainders will be retained. For example, if the divisor was one-hundred twenty-eight, the machine would have three remainders ranging from zero to one-hundred twenty-seven. The remainders may be considered as stops on virtual reels, or conversely, may be related to a particular card of a deck of cards. If the divisor was one-hundred twenty-eight, then the virtual reels would each have one-hundred twenty-eight stops with each stop being equally likely. Each stop on the virtual reel may be mapped to a stop on an actual reel, a displayed reel image, or a displayed card of a deck of cards. These reel images or cards may then be displayed on the display 620. The present invention is operable using any known RNG, and may be integrally programmed as part of the processor 602 operation, or alternatively may be a separate RNG controller 640. RNGs are well known in the art, and any type of RNG may be implemented for the standard mode of play and/or the bonus mode of play in accordance with the invention.

The computing arrangement 600 may also include one or more data storage devices, including hard and floppy disk drives 612, CD-ROM drives 614, and other hardware capable of reading and/or storing information such as DVD, etc. In one embodiment, software for carrying out the standard and bonus gaming operations in accordance with the present invention may be stored and distributed on a CD-ROM 616, diskette 618 or other form of media capable of portably storing information. These storage media may be inserted into, and read by, devices such as the CD-ROM drive 614, the disk drive 612, etc. The software may also be transmitted to the computing arrangement 600 via data signals, such as being downloaded electronically via a network, such as the Internet. Further, as previously described, the software for carrying out the functions associated with the present invention may alternatively be stored in internal memory/storage of the computing device 600, such as in the ROM 606. The computing arrangement 600 is coupled to the display 620, which represents a display on which the gaming activities in accordance with the invention are presented. The display 620 merely represents the “presentation” of the video information in accordance with the invention, and may be any type of known display or presentation screen, such as LCD displays, plasma display, cathode ray tubes (CRT), etc. Where the computing device 600 represents a stand-alone or networked computer, the display 620 may represent a standard computer terminal or display capable of displaying multiple windows, frames, etc. Where the computing device is embedded within an electronic gaming machine, such as slot machine 400 of FIG. 4, or poker machine 500 of FIG. 5, the display 620 corresponds to the display screen 410 of FIG. 4. A user input interface 622 such as a mouse or keyboard may be provided where the computing device 600 is associated with a standard computer. An embodiment of a user input interface 622 is illustrated in connection with an electronic gaming machine 400 of FIG. 4 as the various “buttons” 408. Other user input interface devices include a keyboard, a mouse, a microphone, a touch pad, a touch screen, voice-recognition system, etc.

The computing arrangement 600 may be connected to other computing devices or gaming machines, such as via a network. The computing arrangement 600 may be connected to a network server 628 in an intranet or local network configuration. The computer may further be part of a larger network configuration as in a global area network (GAN) such as the Internet. In such a case, the computer accesses one or more web servers 630 via the Internet 632.

Other components directed to slot machine implementations include manners of gaming participant payment, and gaming machine payout. For example, a slot machine including the computing arrangement 600 may also include a hopper controller 642 to determine the amount of payout to be provided to the participant. The hopper controller may be integrally implemented with the processor 602, or alternatively as a separate hopper controller 642. A hopper 644 may also be provided in slot machine embodiments, where the hopper serves as the mechanism holding the coins/tokens of the machine. The wager input module 646 represents any mechanism for accepting coins, tokens, coupons, bills, credit cards, smart cards, membership cards, etc. for which a participant inputs a wager amount.

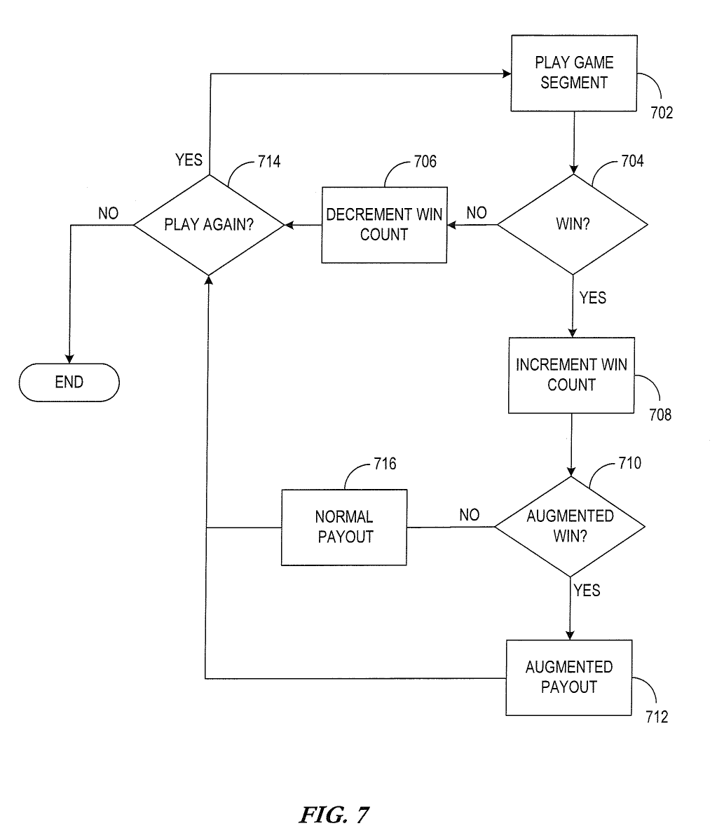

FIG. 7 is a flow diagram illustrating one embodiment of a method of rewarding chained wins in accordance with the present invention. In one embodiment, the chained win award method is implemented in connection with a bonus activity. In another embodiment, the chained win award method is performed in association with a standard gaming activity. Thus, in any standard or bonus gaming activity, a participant executes play of a gaming segment as in step 702. As discussed above, the game segment may be virtually any casino game segment that concludes with a winning or a losing result as determined in step 704.

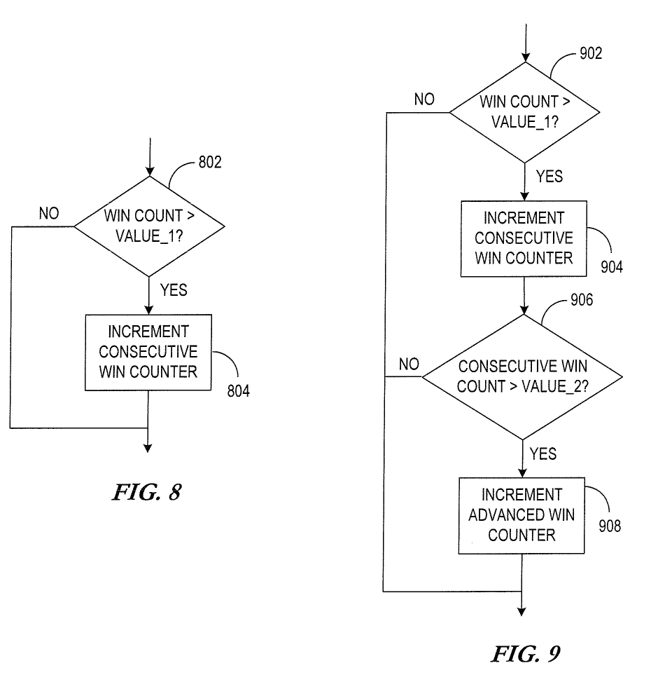

Once a win occurs for a particular gaming segment, one or more win counters are incremented as in step 708, to begin tracking successful completion of gaming segments along with their respective payout amounts. In accordance with one embodiment as exemplified in FIG. 8, a gaming scenario is contemplated where a single counter, e.g., the consecutive win counter, is incremented in step 804 to indicate that a consecutive win has taken place as detected in step 802. The consecutive win counter is compared to a variable, VALUE_1, which may or may not be equal to 1. In one embodiment, VALUE_1 is set to 1, such that if the win count is 2 or more, then the consecutive win counter is incremented. In such an instance, 2 or more consecutive wins constitutes eligibility for consecutive game winner status. In another embodiment, VALUE_1 is set to N, such that if the win count is N or more, the consecutive win counter is incremented. In such an instance, N or more consecutive wins constitutes eligibility for consecutive game winner status.

In an alternate embodiment as exemplified in FIG. 9, two win counters are contemplated for use, e.g., a consecutive win counter and an advanced win counter. In such an instance, upon detection of the occurrence of a consecutive win as defined by VALUE_1 as in step 902, the consecutive win counter is incremented as in step 904. Next, the current count of the consecutive win counter is compared to a predetermined count value, e.g., VALUE_2, as in step 906. If the count associated with the consecutive win counter is greater than VALUE_2, then an advanced win counter is incremented as in step 908 to signify that the user has elevated his level of play into an advanced award status.

In step 710, the award status of the particular game segment is assessed to determine whether a normal payout of step 716 is to be assessed, or whether an augmented payout of step 712 is to be assessed for the current game segment. If winning the current game segment has not earned the gaming participant an augmented payout, then the normal payout for winning the current game segment is nevertheless credited to the gaming participant in step 716. In addition, the current payout amount is saved in step 716 for future access by the augmented payout step of 712, so that augmented payout amounts may be calculated for the successful completion of future game segments that are deserving of augmented payouts. Thus, successive execution of step 716 is effective to create a tracking algorithm used to track the occurrence of the successful completion of multiple game segments along with their respective payout amounts.

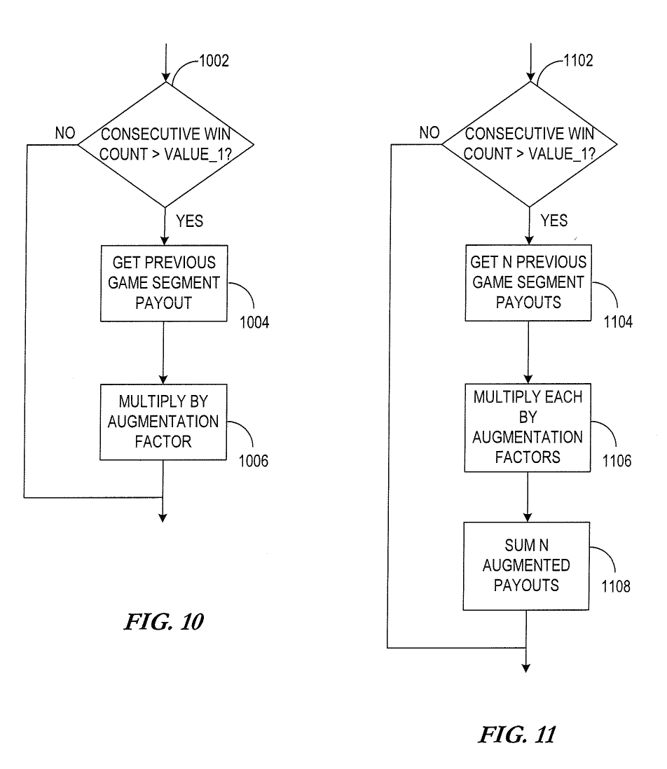

In one embodiment as exemplified in FIG. 10, a normal payout for the game segment is to be implemented, if the consecutive win count is less than a predetermined count value, e.g., VALUE_1, as determined in step 1002. Otherwise, an augmented payout is implemented for the current game segment in step 712 by retrieving the payout amount from a previous game segment and multiplying that payout amount by an augmentation factor in step 1006 as discussed above in relation to FIGS. 1 and 3. Thus, successive execution of step 712 is also effective to create a tracking algorithm used to track the occurrence of the successful completion of multiple game segments along with their respective augmented payout amounts.

In one embodiment, the payout amount for the immediately preceding game segment is retrieved for the calculation of step 1004 and then augmented by an augmentation factor as in step 1006 to calculate the augmented payout for the current game segment. Returning to FIG. 5, for example, the augmented payout for final hand 518 utilizes the immediately preceding game segment payout for hand 514, e.g., 1600, in order to calculate the augmented payout for hand 518.

In an alternate embodiment, the payout amount from a non-adjacent, preceding game segment is retrieved for the calculation of step 1004 and then augmented by an augmentation factor as in step 1006 to calculate the augmented payout for the current game segment. Returning to FIG. 5, for example, the augmented payout for final hand 518 may utilize the payout for non-adjacent hand 510, or hand 504, for the augmented payout determination for hand 518.

In yet another embodiment as exemplified in FIG. 11, a normal payout is to be implemented, if the consecutive win count is less than a predetermined count value, e.g., VALUE_1, as determined in step 1102. Otherwise, an augmented payout is implemented by retrieving N payout amounts from the previous consecutive wins as in step 1104 and multiplying those payout amounts by respective augmentation factors as in step 1106. Returning again to FIG. 5, for example, the augmented payout for hand 518 may alternately be calculated by multiplying the payout amounts for hands 514, 510, and/or 504 by their respective augmentation factors in step 1106 and summed as in step 1108 to determine the augmented payout.

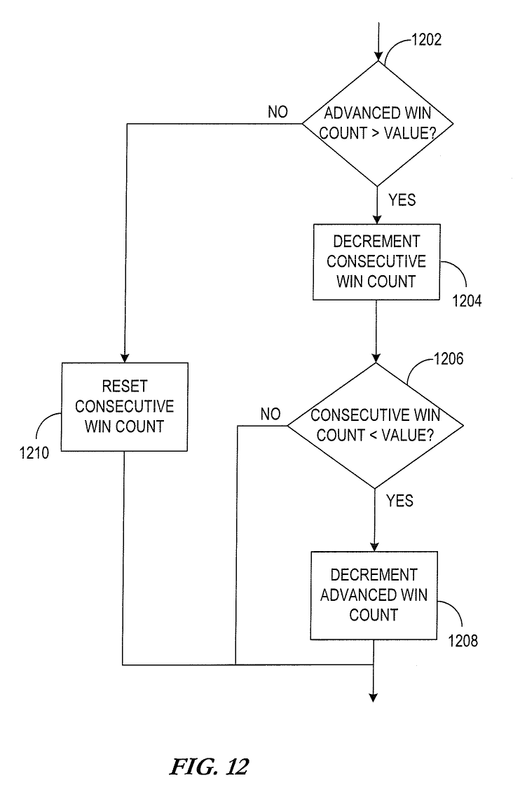

Should game segment 702 result in a loss, on the other hand, then the win counter(s) are to be decremented as in step 706. In one embodiment as exemplified in FIG. 12, a single win counter may be used as discussed above in relation to FIG. 8, in which case the advanced win count is always equal to zero. In such an instance, the consecutive win count is simply reset to zero as in step 1210. In an alternate embodiment using two win counters, the advanced win count is first compared to a predetermined value as in step 1202. If the advanced win count is less than the predetermined count value, then the consecutive win count is simply reset to zero as in step 1210. If, on the other hand, the advanced win count is greater than the predetermined count value, then the consecutive win counter is decremented as in step 1204 instead of being reset. The consecutive win counter is then compared to another predetermined count value as in step 1206. If the consecutive win counter has a value less than the predetermined count value, then the advanced win counter is decremented as in step 1208.

In such an instance, operation in accordance with FIG. 2B is exemplified, whereby a determination is made as to whether the consecutive win counter should be reset, thus ending the gaming participant's eligibility for consecutive game winner status for the next game segment, or whether the consecutive win counter should be decremented, thus continuing the game participant's eligibility for consecutive game winner status for the next game segment despite the loss incurred during the current game segment. It should be noted, that the predetermined count values as used in steps 1202 and 1206 of FIG. 12 are count values that may be independently programmed by, for example, processor 602 of computing device 600. In one embodiment, for example, the predetermined count value used for the advanced win count comparison may be set to 1, in which case the advanced win counter acts merely as a flag to denote whether or not the gaming participant has earned an advanced award status. In the same embodiment, the predetermined count value used for the consecutive win count comparison may be set to, for example, 10, in which case 10 consecutive wins are required in order to increment the advanced win counter to 1 as in step 908 of FIG. 9.

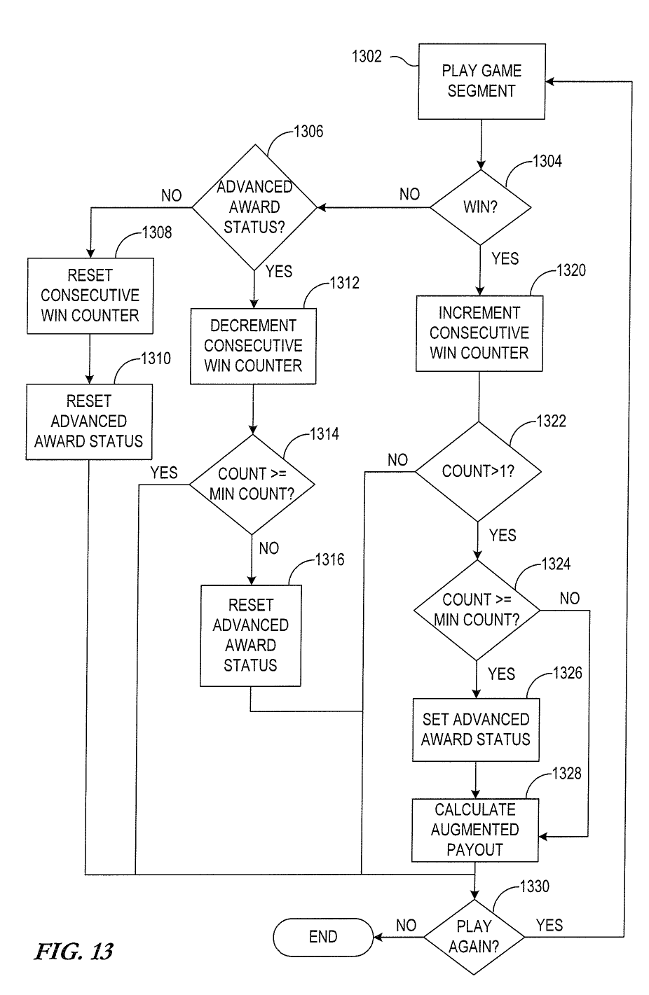

FIG. 13 is an alternate embodiment exemplifying in greater detail a method of rewarding chained wins in accordance with the present invention. In one embodiment, the chained win award method is implemented in connection with a bonus activity. In another embodiment, the chained win award method is performed in association with a standard gaming activity. Thus, in any standard or bonus gaming activity, a participant executes play of a gaming segment as in step 1302. As discussed above, the game segment may be virtually any casino game segment that concludes with a winning or a losing result as determined in step 1304.

If the game segment concludes with a winning result as determined in step 1304, then a consecutive win counter is incremented as in step 1320. The value of the consecutive win counter is then checked in step 1322. If greater than 1, the consecutive win counter is then checked in step 1324 to determine whether it is greater than a predetermined minimum count value. If so, then the participant has achieved a number of consecutive wins that earns an advanced treatment of the consecutive win counter. For example, the advanced award status as signaled by incrementing an advanced win counter is established in step 1326, such that augmentation of winning segment payouts may persist for an extended amount of time as illustrated in FIG. 2B. If, on the other hand, the consecutive win counter has not achieved the predetermined minimum count value, then an augmented payout is nevertheless calculated and credited to the participant in step 1328 as discussed above in relation to FIGS. 1, 3, 4, and 5. It should be noted, that the advanced award status associated with a minimum number of consecutive wins is an optional variation of the present invention. Accordingly, the predetermined minimum count may be set to an arbitrarily high value to effectively deactivate the advanced award status.

If the game segment played in step 1302 does not conclude in a winning result, then the advanced award status is checked in step 1306 for activation. If activated, then instead of resetting the consecutive win counter, it is decremented by one, or some other integer in step 1312. Next, the consecutive win count value is compared to the predetermined minimum count in step 1314. If the consecutive win count is greater than or equal to the predetermined minimum count, then the advanced award status is still active. Otherwise, the advanced award status is no longer active and is reset as in step 1316.

If the game segment played in step 1302 does not conclude in a winning result and the advanced award status is not activated, as determined in steps 1304 and 1306, then the consecutive win counter and the advanced award status is reset as in steps 1308 and 1310. In any event, a determination is made as to whether the participant wishes to participate in another game segment in step 1330 and is executed in accordance with the determination.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, while the gaming activities portrayed in FIGS. 4 and 5 exemplify operation of the present invention in association with video slot machines and video poker machines, it is understood that the present invention may also be practiced using mechanical embodiments of those machines. In particular, mechanical reel slots may be used in place of video reels 422-426 as exemplified in FIG. 4 to achieve virtually identical results. It is intended that the scope of the invention be limited not with this detailed description, but rather determined by the claims appended hereto.

What is claimed is:

1. A method for rewarding successful results in multiple game segments, comprising:
tracking payout amounts obtained in response to successful completion of a plurality of game segments occurring prior to the successful completion of a current game segment;
selecting a group of payout amounts within the plurality of successfully completed game segments; and
augmenting a payout amount for the successful completion of the current game segment in proportion to at least one payout amount within the selected group of payout amounts.

2. The method of claim 1, wherein tracking payout amounts obtained in response to successful completion of the plurality of game segments comprises incrementing at least one win counter in response to the successful completion of a predetermined number of game segments.

3. The method of claim 2, wherein incrementing the at least one win counter includes incrementing a first counter in response to the successful completion of a predetermined number of consecutive game segments.

4. The method of claim 3, wherein incrementing the at least one win counter includes incrementing a second counter in response to a count value of the first counter reaching a first predetermined count value.

5. The method of claim 3, wherein tracking payout amounts obtained in response to successful completion of the plurality of game segments comprises tracking the payout amounts for the game segments counted by the first counter.

6. The method of claim 5, wherein selecting the group of payout amounts within the plurality of successfully completed game segments comprises selecting the payout amounts for the game segments counted by the first counter.

7. The method of claim 6, wherein augmenting the payout amount for the successful completion of the current game segment comprises:
selecting a payout amount of one of the game segments counted by the first counter;
multiplying the payout amount by an augmentation factor; and
adding the multiplied payout amount to the payout amount for the successful completion of the current game segment.

8. The method of claim 7, wherein selecting the payout amount of one of the game segments counted by the first counter comprises selecting the payout amount of the game segment immediately preceding the current game segment.

9. The method of claim 6, wherein augmenting the payout amount for the successful completion of the current game segment comprises:
selecting a plurality of payout amounts from the game segments counted by the first counter;
multiplying each payout amount by a respective augmentation factor; and
adding the multiplied payout amounts to the payout amount for the successful completion of the current game segment.

10. The method of claim 4, further comprising tracking unsuccessful completions of the plurality of game segments.

11. The method of claim 10, wherein tracking unsuccessful completions of the plurality of game segments comprises decrementing the first counter value by one for each unsuccessful completion if the value of the first counter exceeds the first predetermined count value.

12. The method of claim 10, wherein tracking unsuccessful completions of the plurality of game segments further comprises resetting the first counter value if the value of the first counter does not exceed the first predetermined count value.

13. A method for rewarding consecutive winning spins during a free spin bonus activity of a slot game, comprising:
detecting a winning spin during the free spin bonus activity;
tracking occurrences of winning spins subsequent to the winning spin; and
augmenting a payout amount for each subsequent winning spin in proportion to a payout amount associated with a previous winning spin.

14. The method of claim 13, wherein tracking occurrences of winning spins subsequent to the winning spin comprises detecting consecutive winning spins during the free spin bonus activity.

15. The method of claim 14, wherein detecting consecutive winning spins during the free spin bonus activity comprises asserting the occurrence of consecutive winning spins in response to an occurrence of two or more consecutive winning spins.

16. The method of claim 14, wherein augmenting a payout amount for each consecutive winning spin comprises:
retrieving a payout amount for a winning spin immediately preceding a current winning spin;
multiplying the payout amount by an augmentation factor; and
adding the multiplied payout amount to the payout amount for the current winning spin.

17. The method of claim 16, wherein augmenting the payout amount for each consecutive winning spin comprises progressively decreasing the augmentation factor for each consecutive winning spin.

18. The method of claim 17, wherein progressively decreasing the augmentation factor for each consecutive winning spin comprises taking a percentage of the augmentation factor used for the immediately preceding winning spin to compute the augmentation factor used for the current winning spin.

19. The method of claim 16, wherein augmenting the payout amount for each consecutive winning spin comprises progressively increasing the augmentation factor for each consecutive winning spin.

20. The method of claim 17, wherein progressively increasing the augmentation factor for each consecutive winning spin comprises taking a percentage of the augmentation factor used for the immediately preceding winning spin to compute the augmentation factor used for the current winning spin.

21. A casino gaming apparatus hosting a gaming activity having at least a standard mode of operation and a bonus mode of operation, the casino gaming apparatus comprising:
a video screen to present a display grid having a plurality of display cells;
a user interface to facilitate player participation in the standard mode and bonus mode of operation; and
a processor configured to place symbols within the display cells in response to a random symbol placement determination occurring during each game segment of the standard mode and the bonus mode of operation, and during the bonus mode of operation, allocating a number of free game segments, establishing a winning outcome in response to a particular symbol placement, tracking consecutive winning outcomes of the free game segments, and augmenting a payout amount for each consecutive winning outcome in proportion to a payout amount associated with the immediately preceding winning outcome.

22. A method for facilitating participation in a slot game, comprising:
generating winning and losing results during play of a plurality of slot game segments;
tracking a total number of consecutive wins during play of the plurality of slot game segments;
asserting a first award state in response to generating a first number of consecutive winning results; and
augmenting a payout for each consecutive winning result in proportion to a previous winning result payout during the first award state, wherein the first award state is de-asserted in response to a first occurrence of a losing result subsequent to the assertion of the first award state.

23. The method of claim 22, wherein the total number of consecutive wins is reset in response to the first occurrence of the losing result.

24. The method of claim 22, further comprising:
asserting a second award state in response to generating a second number of consecutive winning results, wherein the second number of consecutive winning results is larger than the first number of consecutive winning results; and
augmenting a payout for each consecutive winning result in proportion to a previous winning result, wherein the second award state is de-asserted in response to the occurrence of a number of losing results effective to reduce the total number of consecutive wins below the first number of consecutive winning results.

25. The method of claim 24, wherein the total number of consecutive wins is decremented for each occurrence of a losing result subsequent to the assertion of the second award state.

26. The method of claim 22, wherein augmenting the payout for each consecutive winning result comprises:
retrieving a payout amount for a winning result immediately preceding the current winning result;
multiplying the payout amount by an augmentation factor; and
adding the multiplied payout amount to the payout amount for the current winning result.

27. The method of claim 26, further comprising progressively decreasing the augmentation factor for each consecutive winning result.

28. The method of claim 27, wherein progressively decreasing the augmentation factor for each consecutive winning result comprises taking a percentage of the augmentation factor used for the immediately preceding winning result to compute the augmentation factor used for the current winning result.

29. The method of claim 26, further comprising progressively increasing the augmentation factor for each consecutive winning result.

30. The method of claim 29, wherein progressively increasing the augmentation factor for each consecutive winning result comprises taking a percentage of the augmentation factor used for the immediately preceding winning result to compute the augmentation factor used for the current winning result.
